(19) United States
(12) Patent Application Publication
(10) Pub. No.: US 2025/0077977 A1
(43) Pub. Date: Mar. 6, 2025

(54) SYSTEM PERFORMANCE SIMULATOR

(71) Applicant: Meta Platforms, Inc., Menlo Park, CA (US)

(72) Inventors: Satyajeet Singh Ahuja, Saratoga, CA (US); Zhaodong Wang, Newark, CA (US); Mohammad Noormohammadpour, Redwood City, CA (US); Yuhui Zhang, Sunnyvale, CA (US); Thomas Fuller, San Francisco, CA (US); Mengcheng Wang, Sunnyvale, CA (US); Muhammet Mustafa Ozdal, Menlo Park, CA (US); Abhinav Triguna, Pleasanton, CA (US); Abishek Gopalan, Fremont, CA (US); Jian Yang, Fremont, CA (US); Xin Liu, Foster City, CA (US); Ying Zhang, Fremont, CA (US); Gregory Robbins Steinbrecher, Oakland, CA (US); James Williams, Raleigh, NC (US); Steve Politis, Arvada, CO (US)

(21) Appl. No.: 18/822,593

(22) Filed: Sep. 3, 2024

Related U.S. Application Data
(60) Provisional application No. 63/580,929, filed on Sep. 6, 2023.

(51) Int. Cl. G06N 20/00

(52) U.S. Cl. CPC G06N 20/00

(57) ABSTRACT

Methods, systems, and storage media for running unified simulations on clusters. Exemplary implementations may include: receiving simulation parameters for a simulation of a cluster; generating synthesized workload events based the simulation parameters of the cluster; determining a memory latency associated with the cluster; determining a reliability and availability of resources in the cluster for a predetermined duration of time; simulating events for jobs in the cluster based on the reliability and availability of resources in the cluster, each job associated with one or more synthesized workload events; and outputting simulation results based on the synthesized workload, the memory latency, and the events.

### CROSS-REFERENCE TO RELATED APPLICATIONS

The present disclosure is related and claims priority under 35 U.S.C. § 119 (e) to U.S. Prov. Appln. No. 63/580,929, entitled UNIFIED SYSTEM SIMULATIONS to Satyajeet Singh Ahuja, et al., filed on Sep. 6, 2023, the contents of which are hereby incorporated by reference in their entirety, for all purposes.

### TECHNICAL FIELD

The present disclosure generally relates to a simulator for training systems using data-driven decision-making processes, and more particularly to improving end-to-end (E2E) system performance simulators, for example, used for simulating artificial intelligence (AI) training clusters.

### BRIEF SUMMARY

The subject disclosure provides for systems and methods for running unified system simulations on AI training clusters. One aspect of the present disclosure relates to a method of unified system simulations on clusters. The method may include receiving, from a user, simulation parameters for a simulation of a cluster. The method may include generating synthesized workload events based the simulation parameters of the cluster. The method may include determining a memory latency associated with the cluster. The method may include determining a reliability and availability of resources in the cluster for a predetermined duration of time. The method may include simulating events for jobs in the cluster based on the reliability and availability of resources in the cluster, each job associated with one or more synthesized workload events. The method may include outputting simulation results based on the synthesized workload, the memory latency, and the events.

Another aspect of the present disclosure relates to a system configured for performing unified system simulations for clusters. The system may include one or more hardware processors configured by machine-readable instructions. The processor(s) may be configured to receive, from a user, simulation parameters for a simulation of an AI training cluster. The processor(s) may be configured to generate synthesized workload events based the simulation parameters of the AI training cluster, the AI training cluster comprising one or more nodes in a network. The processor(s) may be configured to determine a memory latency associated with the AI training cluster. The processor(s) may be configured to determine a reliability and availability of resources in the AI training cluster for a predetermined duration of time. The processor(s) may be configured to simulate events for jobs in the AI training cluster based on the reliability and availability of resources in the AI training cluster, each job associated with one or more synthesized workload events. The processor(s) may be configured to output simulation results based on the synthesized workload, the memory latency, and the events.

Yet another aspect of the present disclosure relates to a non-transient computer-readable storage medium having instructions embodied thereon, the instructions being executable by one or more processors to perform a method for running unified system simulations on clusters. The method may include receiving from a user, simulation parameters for a simulation of an AI training cluster. The method may include generating synthesized workload events based the simulation parameters of the AI training cluster, the AI training cluster comprising one or more nodes in a network. The method may include determining a memory latency associated with the AI training cluster. The method may include determining a reliability and availability of resources in the AI training cluster for a predetermined duration of time. The method may include simulating events for jobs in the AI training cluster based on the reliability and availability of resources in the AI training cluster, each job associated with one or more synthesized workload events. The method may include outputting simulation results based on the synthesized workload, the memory latency, and the events.

Still another aspect of the present disclosure relates to a system configured for unified simulations. The system may include means for receiving, from a user, simulation parameters for a simulation of a cluster. The system may include means for generating synthesized workload events based the simulation parameters of the cluster. The system may include means for determining a memory latency associated with the cluster. The system may include means for determining a reliability and availability of resources in the cluster for a predetermined duration of time. The system may include means for simulating events for jobs in the cluster based on the reliability and availability of resources in the cluster, each job associated with one or more synthesized workload events. The system may include means for outputting simulation results based on the synthesized workload, the memory latency, and the events.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a network architecture in which methods, apparatuses, and systems described herein may be implemented.

FIG. 2 illustrates an exemplary system architecture of a unified simulation system 200, in accordance with one or more implementations.

FIG. 3 is an example table summarizing different modes of the network simulator, in accordance with one or more implementations.

FIG. 4 is an exemplary detailed block diagram of aspects of an orchestrator and workload synthesizer, in accordance with one or more implementations.

FIG. 5 is an exemplary diagram of job event state-transitions, in accordance with one or more implementations.

FIG. 6 is an exemplary workflow of the network simulator, in accordance with one or more implementations.

FIG. 7 illustrates example segments generated by flow segmentation, in accordance with one or more implementations.

FIG. 8 is an exemplary detailed block diagram for data-driven input generation in a unified simulation system, in accordance with one or more implementations.

FIG. 9 illustrates exemplary graphical representations of behavior distributions, in accordance with one or more implementations.

FIG. 10 illustrates an exemplary graphical comparison of two model parameters in a two-dimensional space, in accordance with one or more implementations.

FIG. 11 illustrates a system configured for running unified system simulations on clusters, in accordance with one or more implementations.

FIG. 12 is an example flow diagram of a process for running unified system simulations for clusters, in accordance with one or more implementations.

FIG. 13 is a block diagram illustrating an example computer system with which aspects of the subject technology can be implemented.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

### General Overview

High-performance computing (HPC) clusters are a collection of specialized hardware, including a group of large and powerful components (also referred to as “nodes”) including, but not limited to, computers, servers, and/or computing devices, and a distributed processing software framework. The HPC cluster is configured to handle massive amounts of data at high speeds with parallel performance and high availability. The large-scale multi-layered system tracking/monitoring performance of said clusters may include thousands of accelerators, AI workloads, networks, compute resources, memory, scheduling, and applications, and needs a significant amount of training time. This makes tracking and predicting AI workload characteristics challenging and E2E accuracy of training performance challenging.

Training cluster performance is influenced by multiple pillars: compute, memory, and network. Typically, separate frameworks exist to evaluate performance of each pillar with the other pillars assumed to be abstracted. Standard cluster performance training also does not include an agreed source of truth that jointly models the three pillars, leading to local optimization that can be disconnected from reality, and no structured way to identify Return on Investment (ROI) across different initiatives, which in turn leads to manually identified execution priority. Additionally, operational workflows are not executed based on data driven operations.

A training cluster may comprise, for example, a collection of interconnected computing resources designed to train artificial intelligence models, such as graphics processing units (GPUs). The traditional collective pattern requires GPUs to exchange data in a one-to-one and distributed manner. Thus, the communication complexity due to link delay between GPUs is O(n), where n is the number of GPUs involved, and is non-scalable.

Embodiments describe a solution to the above identified problems by fostering data-driven decision-making processes using a unified simulation system that models compute, memory, and network hardware performance. According to embodiments, the unified framework includes a single source of truth that is agreed upon across stakeholders. The unified simulation system also accounts for network-compute feedback loops between nodes of a cluster. The unified simulation system is designed to be adaptable, allowing for joint-evolution of models and different hardware variations. In some embodiments, the system utilizes a common framework used by hardware, network, job-scheduling, and AI systems' co-design teams.

According to embodiments, the unified simulation system makes it easier for users to customize their simulations and submit requests via a user interface of the systems. The unified simulation system is designed to be easily extensible and modular. As such, new features can easily be added, and the system can be adapted to support new use cases. The use of abstract classes for various components (e.g., job generators, failure generators, and loggers) allows for easy customization and extension. The modular design of the architecture also makes it easy to test. Individual components can be isolated and tested separately, making it easier to identify and fix issues. This contributes to the overall maintainability of the unified simulation system, ensuring it can be effectively updated and improved over time.

The disclosed system(s) address the technical challenge of tracking and optimizing training cluster performance. The disclosed system solves this technical problem by providing a solution also rooted in computer technology, namely, by providing a unified framework that models compute, memory, and network hardware performance. The disclosed subject technology further enhances the functioning of the computer itself by improving processing and accuracy in performance simulation systems. The framework includes a simulator for artificial intelligence (AI) training clusters which enables better design, monitoring and operation of AI training clusters. According to some embodiments, the simulator uses discrete event simulation to ensure reliable and accurate modeling of complex systems. This enables precise simulations that can be trusted for decision-making.

According to embodiments, the simulator includes in-network compute capabilities. The simulator can model the behavior of providers configured to optimize the completion time of a distributed computing system by performing specific computations across the network. The implementation of in-network computing technology improves the training performance by offloading collective operations (e.g., AllReduce) from GPUs to the network switches. Thus, in-network computing can mitigate the overhead of sending data multiple times between GPUs. In-network computing utilizes switches as aggregation nodes to construct a logical tree. Within this tree structure, data aggregation occurs at each node, progressively ascending to the tree's root. This aggregated result is then redistributed from the tree root, cascading down to the GPUs. By eliminating the need for direct data exchange among GPUs, in-network computing can reduce the communication complexity (e.g., to O(1)) and significantly enhance scalability.

Other improvements provided by embodiments include vetting operational workflows with simulations enabling greater understanding of risk, mitigation plans and enhancing visibility towards workload level impact via: simulation-based audits for AI/HPC network maintenance, optimizing maintenance scheduling, improving production AI/HPC job scheduling and collective communication library (e.g., NCCL) configurations, network and/or hardware topology design, and debugging and root-causing production events.

### Example System Architecture

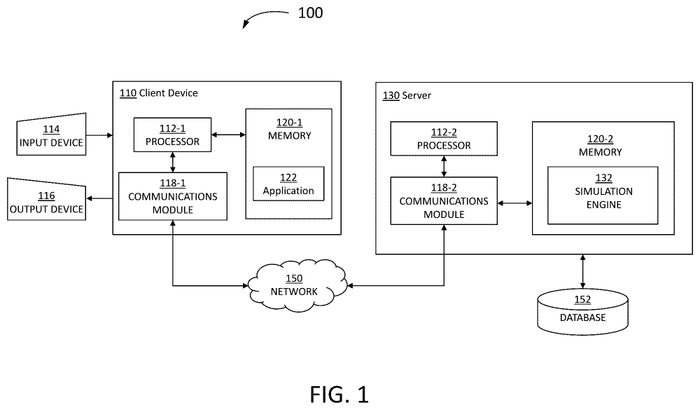

FIG. 1 illustrates a network architecture 100 in which methods, apparatuses, and systems described herein may be implemented. Architecture 100 may include servers 130 and a database 152, communicatively coupled with multiple client devices 110 via a network 150. Any one of servers 130 may host a social media platform running on client devices 110, used by one or more of the participants in the network. The servers 130 may include a cloud server or a group of cloud servers. In some implementations, the servers 130 may not be cloud-based (i.e., may be implemented outside of a cloud computing environment) or may be partially cloud-based. Client devices 110 may include any one of a laptop computer, a desktop computer, or a mobile device such as a smart phone, a palm device, or a tablet device.

Client device 110 and server 130 are communicatively coupled over network 150 via respective communications modules 118-1 and 118-2 (hereinafter, collectively referred to as “communications modules 118”). Communications modules 118 are configured to interface with network 150 to send and receive information, such as requests, responses, messages, and commands to other devices on the network 150. Communications modules 118 can be, for example, modems or Ethernet cards, and may include radio hardware and software for wireless communications (e.g., via electromagnetic radiation, such as radiofrequency -RF-, near field communications -NFC-, Wi-Fi, and Bluetooth radio technology). Client device 110 may be coupled with an input device 114 and with an output device 116. A user may interact with client device 110 via the input device 114 and the output device 116. Input device 114 may include a keyboard, a mouse, a pointer, or even a touch-screen display that a consumer may use to interact with client device 110. Likewise, output device 116 may include a display and a speaker with which the consumer may retrieve results from client device 110.

Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like, and/or a combination of these or other types of networks.

Client device 110 may also include a processor 112-1, configured to execute instructions stored in a memory 120-1, and to cause client device 110 to perform at least some of the steps in methods consistent with the present disclosure. Memory 120-1 may further include an application 122 (e.g., user application including a user interface to facilitate interactions with the unified simulation system). The application 122 may include specific instructions which, when executed by processor 112-1, cause data/information from server 130 to be displayed for a consumer. By non-limiting example, the application 122 runs on any operating system (OS) installed in client device 110. In some embodiments, the application 122 may be downloaded by the user from the server 130 and may be hosted by the server 130. In some embodiments, application 122 may run out of a web browser. In some embodiments, the processor is configured to control a graphical user interface (GUI) for the user of one of client devices 110 accessing the server of the social platform.

Server 130 includes an application programming interface (API) layer 115, which controls application 122 in each of client devices 110. Hereinafter, processors 112-1 and 112-2, and memories 120-1 and 120-2, will be collectively referred to, respectively, as “processors 112” and “memories 120.” Processors 112 are configured to execute instructions stored in memories 120. In some embodiments, memory 120-2 includes a simulation engine 132. The simulation engine 132 may be configured to run simulations for network designs for testing, scheduling, etc., and may be applied to AI training networks. The simulation engine 132 may simulate this network behavior at various levels/modes. According to embodiments, the simulation engine 132 leverages a process-based discrete-event simulation framework. The framework may include a Cluster and ClusterUnit to track the usage of cluster resources, job event to track job status, and a process to model generation functions, as well a sequence of events that occur over time.

Users may access engine 132 through application 122, installed in memory 120-1 of client device 110. Accordingly, application 122 may be installed by servers 130 and perform scripts and other routines provided by servers 130 through any one of multiple tools. Execution of application 122 may be controlled by processor 112-1. Servers 130 may include an application programming interface (API) layer, which controls applications in the client device 110. The API layer may also provide tutorials to users of the client device 110 as to new features in the application 122, allowing for easy customization and extension of the simulation engine 132.

### Example Simulation System Architecture

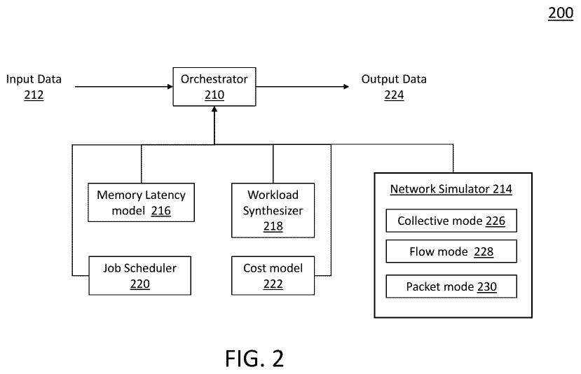

FIG. 2 illustrates an exemplary system architecture of a unified simulation system 200, according to one or more embodiments. The system 200 includes an orchestrator 210, network simulator 214, memory latency model 216, workload synthesizer 218, job scheduler 220, and cost model 222.

According to embodiments, the orchestrator 210 is configured to orchestrate between a sequence of events in a simulation for a network design, or the like, running on a cluster. The orchestrator 210 may be a multi-level discrete-event simulator. Each event may occur at an instant in time and mark a change of state in the system 200.

The orchestrator 210 may receive input data 212 from one or more sources and the memory latency model 216, workload synthesizer 218, job scheduler 220, cost model 222, and network simulator 214. The input data 212 may include, but is not limited to, system inputs from a user, administrator, or the like. The user may input simulation parameters, restrictions, a query, or the like. According to embodiments, the user may modify the cluster before, after, or during a simulation. As such, the orchestrator 210 may continuously accept inputs at any time during the simulation. By non-limiting example, the user may specify a type of cluster they want to run and what kind of AI workload the network simulator 214 should simulate. As another non-limiting example, the user may specify settings of the infrastructure including reliability of the cluster components (e.g., GPU rack servers or jobs). System inputs may include, but are not limited to, plans (e.g., long range plans or floor plans), topology/routing data, workload distributions, hardware specifications, failure domains, etc. The input data 212 may be received at a client device (e.g., client device 110).

The network simulator 214 is configured to simulate network behavior. The network simulator 214 can run for any network design or model developed using the orchestrator 210. The network simulator 214 may run various simulations for testing, monitoring, and/or operating one or more aspects of the network design. The network simulator 214 may run according to different modes: collective mode 226, flow mode 228, and packet mode 230. The different modes are used to simulate the network behavior based on user needs in a network design. Each mode may correspond to different levels of network details, balancing time against the level of detail needed for the network design.

The memory latency model 216 may be configured to compute a memory latency of the cluster simulation. The memory latency is a critical factor in, for example, the performance of an AI training cluster.

The job scheduler 220 may be configured to perform job scheduling in the cluster. In some embodiments, the job scheduler 220 may generate jobs (e.g., AI training jobs) and simulate the job-related events (hereafter “job events”) for the cluster.

Workload synthesizer 218 may be configured to simulate workload events to illustrate the behavior and performance characteristics within a workload. The workload may represent a job scheduled on the cluster. Each job event, simulated by scheduler 220, may correlate to one or more workload events. Workload synthesizer 218 may simulate workload based on a hierarchal generative AI model(s) and output synthesized workloads that are similar to the workload performance of the cluster.

Cost model 222 is configured to simulate cost (e.g., capital/operational expenditures) associated with the cluster. Simulating cost may include determining computational resource usage of the cluster based on a cost model. Outputs of the simulation may be generated based on the computational resource usage.

The orchestrator 210 may output results (i.e., output data 224) of the simulations to a user interface (e.g., at client device 110) based on the input data 212. Simulation results may include, but are not limited to, training/inference performance, cost, resource utilization, reliability, availability, etc.

The unified simulation system 200, according to one or more embodiments, may be applicable to many use cases including, but not limited to, generating results for: cluster utilization and fragmentation; impact of network; hardware on AI/HPC job performance; AI/HPC job profile in the training cluster's reliability, availability and efficiency of training clusters; optimization of training cluster maintenances; and optimization of AI/HPC job scheduling and configurations.

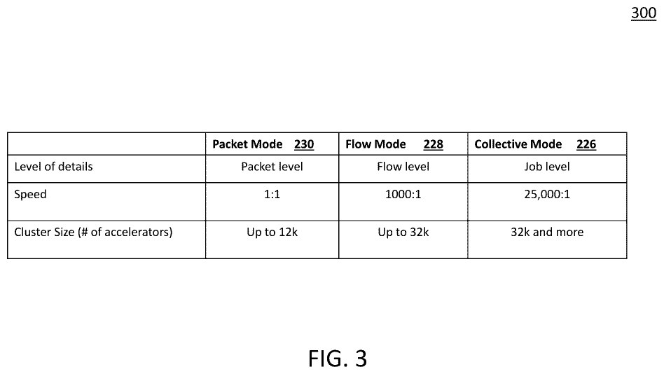

FIG. 3 is an example table 300 summarizing different modes of the network simulator 214, according to aspects of embodiments. A mode may be selected based on parameters of a given cluster. The trade-off between each mode involves speed and the level of detail needed for a network design. As shown in FIG. 3, the modes include collective mode 226, flow mode 228, and packet mode 230.

Packet mode 230 runs the simulation at the packet level. For example, operational workflows may be vetted in the simulations based on packet level details. In some embodiments, packet mode 230 may operate in real-time (or nearly real-time) with a 1:1 ratio between real-world time and simulation time. In some embodiments packet mode 230 may be ideal for a cluster size of up to about 12,000 accelerators. Packet mode 230 may be favorable for performance simulations related to, for example, hardware specifications, network interface card (NIC) design, accelerator design, and switch architecture. By non-limiting example, if a user is interested in designing different network hardware, the network simulator 124 may simulate in packet mode 230 which simulates the network based on hardware level parameters (i.e., packet by packet with a smaller cluster size) to capture finer behavioral details in the network.

Flow mode 228 runs the simulation at the flow level. For example, operational workflows are vetted in simulations based on flow level details. In some embodiments, the speed of the flow mode 228 may operate at a ratio of 1000:1 between real-world time and simulation time, thus, operating at about 1000 times faster compared to packet mode 230. In some embodiments, flow mode 228 may be ideal for a cluster size of up to about 32,000 accelerators. Flow mode 228 may be favorable for performance simulations related to, for example, network topology, routing protocols, flow control, bandwidth, and switch/optics latencies. By non-limiting example, given a network design that only cares about a higher level of the network behavior, the network simulator 214 may simulate in flow mode 228 which simplifies (e.g., relative to packet mode 230) the simulation to provide higher level network metrics.

Collective mode 226 (also referred to as “job/fast mode”) runs the simulation at the job level. For example, operational workflows are vetted in simulations based on AI/HPC job level details. In some embodiments, the speed of the flow mode 228 may operate at a ratio of 25,000:1 between real-world time and simulation time, thus, operating at about 25 times faster compared to flow mode 228. In some embodiments, collective mode 226 may be ideal for a cluster size of 32,000 or more accelerators. Collective mode 226 may be favorable for performance simulations related to, for example, job waiting time, allocation efficiency, cluster availability, and resource utilization. By non-limiting example, given a network design that does not require underlying network behavior and focuses more on job level problems (e.g., scheduling related issues), the network simulator 214 may simulate in collective mode 226. The collective mode 226 will only simulate higher level job behaviors and run at high speed.

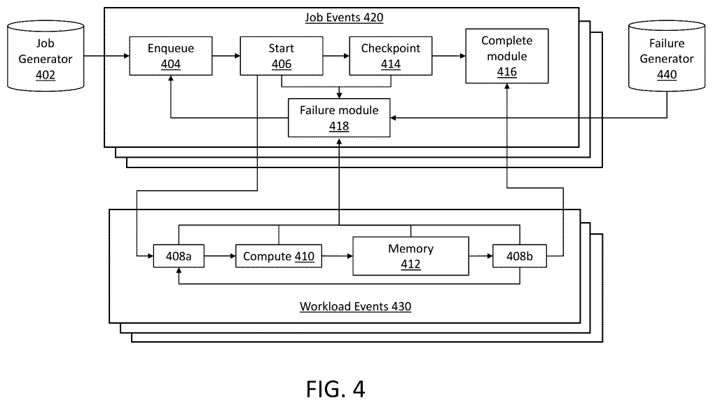

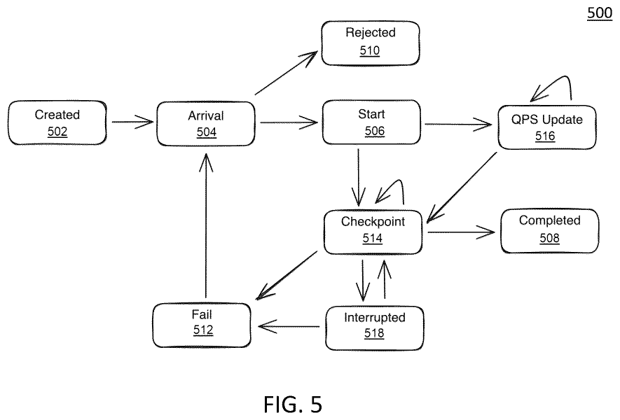

FIG. 4 is an exemplary detailed block diagram of aspects of the orchestrator 210 and the workload synthesizer 218, according to aspects of embodiments. Aspects of FIG. 4 model the lifetime of jobs generated at the orchestrator 210. Job events may transition between various states in their lifetime examples of which are illustrated in FIG. 4, and further detailed in FIG. 5.

As shown in FIG. 4, the orchestrator 210 may include a job generator 402 and failure generator 440. Job generator 402 may be configured to generate jobs based on simulation criteria for the network design (e.g., at least input data 212). The job generator 402 may be configured to track the usage of cluster resources. In some embodiments, the job generator 402 allocates cluster resources to a job and/or releases cluster resources from a job. The generated jobs are added to an enqueue 404 for simulation. During simulation, jobs may experience one or more job events and status changes in the simulation.

The failure generator 440 is a random generator configured to determine when a failure may occur in a cluster and generate the failures in the simulation. The failure generator 440 may simulate a cluster failure, making it unavailable for jobs. According to some embodiments, the orchestrator 210 includes a recover component that is configured to simulate a cluster recovery from failure, making it available again for jobs. Failures may include, but are not limited to, hardware failures, software failures, model training failures, or the like. Each cluster failure has a correspond mean time to failure and the failure generator 440 aims to generate or model the failures in the simulation.

Job events 420 may support various job event types and may be used to track job status. Job events 420 model job status changes by yielding a job event in the simulation. When job events 420 yields an event, the job is paused, and other processes continue to run. When the event is triggered, the job event continues from where it left off. This prevents, for example, the simulation from losing the progress of the job (e.g., up until the failure).

Each job begins at start 406 based on a sequence of the enqueue 404 and may complete or fail. Checkpoint 414 may be configured to determine whether a job completes or fails. When a job fails, the job is sent to the failure module 418 which tracks the status transition. When a job completes, the job is sent to the complete module 416 which tracks the status transition. According to embodiments, a job that fails is sent back to the enqueue 404 and restarts the simulation again. In some embodiments, the checkpoint 414 may be activated at predetermined time intervals. Checkpoint 414 may store data or metadata associated with the job event in a database, or the like. The stored data may include, but is not limited to, data from any stage of the process when running the simulation, performance data, time data, tracking data, event identifier information, etc. Given a job can fail at any time in its lifetime, interval checks prevent the entire simulation for all the jobs from restarting from beginning at every failure (e.g., in response to one failed job).

According to some embodiments, the orchestrator 210 is a multi-level discrete event simulator. Each job may be simulated based on one or more workload events 430 generated by the workload synthesizer 218. A shown in FIG. 4, the workload events 430 may include, for example, communication events 408a/408b (hereafter “communication events 408”), compute events 410, and memory events 412. According to some embodiments, the orchestrator 210 builds a stack and simulates the behavior within the workload based on the events of the workload. By non-limiting example, communication events 408 may include communication between one or more machines, GPUs, or the like, in a network.

According to embodiments, an in-network compute feature is implemented, offloading collective operations from GPUs to network switches. This can mitigate the overhead of sending data multiple times between GPUs and improves training performance. The cornerstone of in-network computing lies in the construction of logical trees, which is essential for efficient data aggregation and transmission. Each training job is associated with multiple logical trees, with the quantity of trees corresponding to the number of rails in the network infrastructure.

The process of logical tree construction typically involves the following steps: tree root candidate identification, intermediate node selection, and data allocation. Tree root candidate identification finds all Lowest Common Ancestors (LCAs) of hosts as candidate tree roots, and then selects one to serve as the tree root. Intermediate node selection progressively chooses nodes for intermediate layers, forming a path from each host to the root. Data allocation distributes collective data evenly across each logical tree, ensuring balanced data handling.

According to embodiments, to accommodate various network behaviors, two logical tree construction algorithms may be implemented: greedy and random. The greedy logical tree construction algorithm prioritizes underutilized switches for aggregation to spread network usage and balance load distribution. The random logical tree construction algorithm selects switches randomly, ensuring a more diversified and resilient network usage.

FIG. 5 is an exemplary diagram of job event state-transitions 500, according to aspects of embodiments. By non-limiting example, the job event state-transitions 500 may be included in job events 420. Created 502 corresponds to the event that a job is created. Arrival 504 corresponds to the event that a job arrives at the waiting queue. For example, the job generator creates the job, and the job arrives at enqueue 404 and waits in queue. Started 506 corresponds to the event that a job starts training. Completed 508 corresponds to the event that a job completes training. Rejected 510 corresponds to the event that a job is rejected when waiting at queue. Fail 512 corresponds to the event that a job fails during training. Checkpoint 514 corresponds to the event that a job rolls back to a previous checkpoint training progress. QPS update 516 corresponds to the event that a job's queries per second (QPS) is updated due to network dynamics. Interrupted 518 corresponds to the event that a job is interrupted during training due to failures.

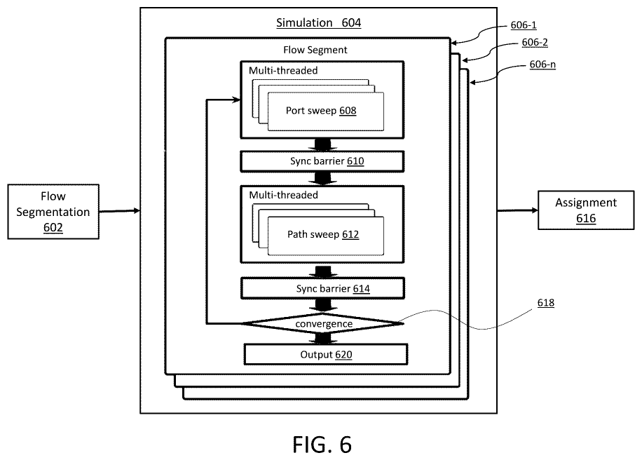

FIG. 6 is an exemplary workflow of the network simulator 214, according to aspects of embodiments. The network simulator 214 is configured to simulate network behavior associated with nodes in a cluster (e.g., communication events 408a/408b). In some embodiments, the network simulator 214 may be a large-scale AI network simulator. The network simulator 214 may run at various levels including, for example, collective mode 226, flow mode 228, and packet mode 230 (as described in FIG. 3). For exemplary purposes, FIG. 6 demonstrates a flow-level network simulation, according to some embodiments.

When simulating network behavior in a cluster, the number of flows grows significantly as the number of nodes in the network increases. Time required to simulate the behavior of the network on a single thread will also increase at a rate faster than linear growth (e.g., proportional to the square of the network size) as the network expands, presenting a scaling challenge when simulating larger networks and/or clusters.

To address this scaling challenge, flow segmentation 602 is configured to identify all flows in the network and segment the flows into a plurality of flow segments, for example, flow segment 606-1, flow segment 606-2, . . . flow segment 606-n (hereafter collectively referred to as “flow segments 606”). In some embodiments, flow segmentation 602 identifies flows that do not have any intersection points when they are going through network nodes (e.g., network machine, devices, ports, etc.).

Simulation 604 is configured to run the simulation on the flow segments 606. The flow segments 606 may be simulated on independent threads running in parallel, speeding up the simulation. This may include simulating the flow segments 606 on independent CPUs and/or CPU cores that run in parallel.

According to embodiments, each of the flow segments 606 may implement different rate allocation mechanisms. The network simulator 214 may select a rate allocation mechanism based on the size of the cluster and run simulation 604 according to the selected mechanism. Basic rate allocation mechanisms identify bottlenecks in the flow and fixes the rate for each bottleneck. This rate allocation mechanism may not be efficient for larger clusters (e.g., clusters with more than a predetermined number of nodes) due to the processing time required to find bottlenecks and fix the rates.

According to embodiments, the network simulator 214 may implement a water-filling loop rate allocation mechanism made up of a two-stage algorithm. In the two-stage algorithm, the allocation for all the segment flows is increased until at least one of the flows is satisfied. A flow (or flow segment) may be satisfied when it reaches a bottleneck. When the at least one flow is satisfied, a rate is fixed for the at least one flow and the rate for the remaining flows are increased.

According to embodiments, there exists a minimum contention among threads, representing the lowest level of competition or conflict between nodes in the network. This scenario occurs when interactions between nodes in the network are at its least, resulting in minimal interference between the nodes.

In the first stage of the algorithm, the simulation 604 performs a port sweep 608 on flow in a thread pool to identify ports in the cluster and assigns rates to the flows at each port in the cluster. Each of the flow segments 606 in the multi-threaded thread pool is repeating the same logic. The threads may be locked at sync barrier 610 until all the threads have been swept. When a flow is swept at port sweep 608, assignment 616 allocates the rate to the threads. According to some embodiments, at least a portion of the rates are assigned while the port sweep 608 is still running. Sync barrier 610 locks threads until the port sweep 608 completes a port sweep for the entire cluster before allowing the simulation 604 to proceed further. That is, the simulation 604 waits for all the threads to complete the port sweeping by locking threads at sync barrier 610. Upon completion of the port sweeping, all the rates have been fixed and another sweeping occurs in a second stage of the algorithm.

In the second stage of the algorithm, the simulation 604 performs a path sweep 612 on all the flow paths in the cluster and identifies a minimum rate. In some embodiments, paths and ports may have intersections between them depending on which flow is using which path and/or port. Threads may be locked at sync barrier 614 until the path sweep 612 is complete for all flows/flow segments. The path sweep 612 is performed for all the threads in parallel. This implementation leverages full parallelism across nodes (e.g., server CPUs) within each sweep stage (i.e., port sweep 608 and path sweep 612) by accessing flow transmission rates in a way that does not require data synchronization and hence is lockless between sweeping stages.

According to embodiments, convergence 618 determines when the algorithm converges. The port and path sweeping may repeat, executing the water-filling loop rate allocation mechanism, until all rates converge to their final values. The final rate is provided as an output 620 of the simulation 604. The water-filling loop rate allocation mechanism leverages full parallelism across nodes (e.g., server CPUs) within each sweep stage (i.e., port sweep 608 and path sweep 612) by accessing flow transmission rates in a way that does not require data synchronization and hence is lock-free with the only locks being at synchronization barriers (e.g., sync barrier 610 and 614).

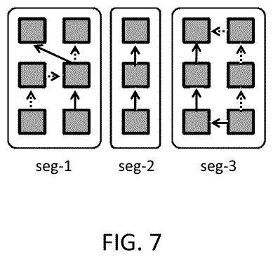

FIG. 7 illustrates example segments generated by flow segmentation 602. More specifically, FIG. 7 demonstrates that in a given network there may be different segments with intersections (e.g., seg-1 and seg-3) and segments without any intersections (e.g., seg-2). According to embodiments, the segments are comprised of multiple flows.

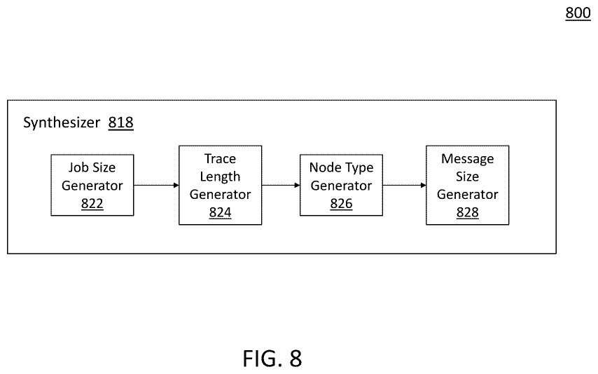

FIG. 8 is an exemplary detailed block diagram for data-driven input generation 800 in a unified simulation system, according to aspects of embodiments. As shown in FIG. 8, the inputs may be generated at a workload synthesizer 818 (e.g., corresponding to workload synthesizer 218). The workload synthesizer 818 is configured to simulate AI workloads (e.g., AI models). Each AI workload represents a training job scheduled on a given training cluster.

The workload synthesizer 818 may analyze all the existing AI models being trained to the cluster and may extract model properties. Model properties may include, but are not limited to, job size determined and extracted by job size generator 822, trace length determined and extracted by trace length generator 824, node type determined and extracted by node type generator 826, and message size determined and extracted by message size generator 828. The model properties are used for AI workload synthesis. Each of the generator modules (shown in FIG. 8) may analyze all the existing AI models being trained on the cluster and the respective extract model properties (e.g., job size, trace length, node type, message size, etc.) and then run one or more clustering algorithms.

In some embodiments, based on results of the clustering, the workload synthesizer 818 may determine how many clusters the jobs can form. One of the jobs may be selected as a representative job in each cluster and used as input to the simulator, easily reproducing behavior similar to the training cluster. By non-limiting example, different nodes in a network/cluster may be exchanging different sized messages which will affect network utilizations.

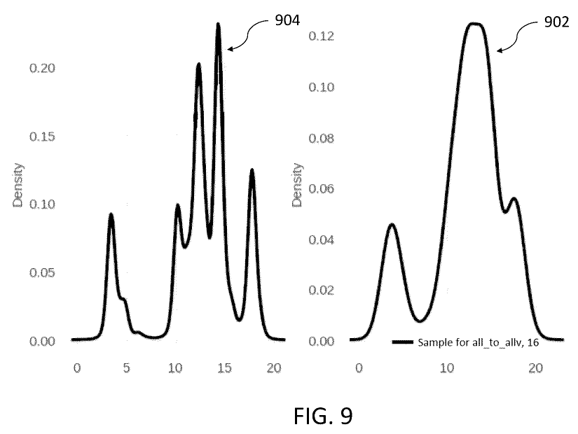

FIG. 9 illustrates a graphical representation of a synthesized behavior distribution 902 corresponding to, for example, message size produced by the simulation and an actual production distribution 904 of the network. As shown in FIG. 9, the behavior distribution is similar between the synthesized behavior distribution 902 and the actual production distribution 904 of the job. AI job behaviors may be sampled to generate the synthesized behavior distribution 902, which yields similar results to the true value.

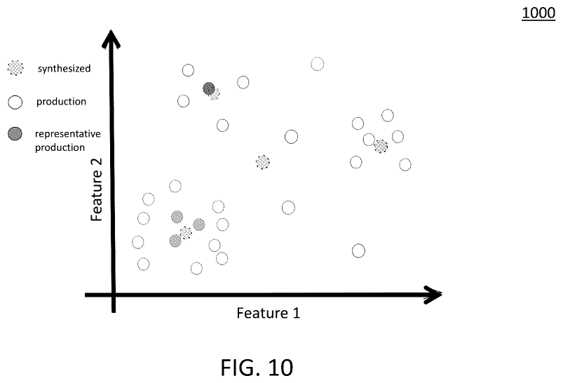

FIG. 10 is an exemplary graphical comparison (i.e., graph 1000) of two different model parameters (e.g., feature 1 and feature 2) in a two-dimensional space. As shown in FIG. 10, jobs are represented as two-dimensional nodes and the nodes automatically form clusters, following a high dimensional probability distribution. Graphical representations of the synthesized workload, production (e.g., actual workload or behavior of the cluster), and representative production of clusters are provided in the graph 1000.

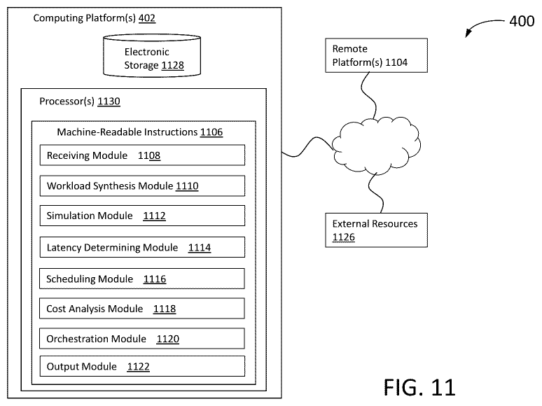

FIG. 11 illustrates a system 1100 configured for running unified system simulations on clusters, in accordance with one or more implementations. In some implementations, system 1100 may include one or more computing platforms 1102. Computing platform(s) 1102 may be configured to communicate with one or more remote platforms 1104 according to a client/server architecture, a peer-to-peer architecture, and/or other architectures. Remote platform(s) 1104 may be configured to communicate with other remote platforms via computing platform(s) 1102 and/or according to a client/server architecture, a peer-to-peer architecture, and/or other architectures. Users may access system 1100 via remote platform(s) 1104.

Computing platform(s) 1102 may be configured by machine-readable instructions 1106. Machine-readable instructions 1106 may include one or more instruction modules. The instruction modules may include computer program modules. The instruction modules may include one or more of receiving module 1108, workload synthesis module 1110, simulation module 1112, latency determining module 1114, scheduling module 1116, cost analysis module 1118, orchestration module 1120, output module 1122, and/or other instruction modules.

Receiving module 1108 may be configured to receive an input designating, describing, or defining a cluster for which a simulation is to be run. The cluster may be a high-performance computing cluster comprising one or more nodes (e.g., GPUs, servers, server racks, etc.) in a network. The input may further include simulation parameters, specifications, and/or instructions. Simulation parameters may include, but at not limited to, a cluster type, AI workload desired for simulation, settings of a network infrastructure of the cluster, reliability and/or availability of one or more nodes of the network infrastructure. The availability may indicate how much time and resources are available. The reliability may indicate, for available resources, the likelihood the resource is available for a certain duration of time.

In some implementations, the system 1100 is configured to determine a reliability and availability of resources in the cluster for a predetermined duration of time based on the input. In some implementations, the simulation may be launched based on receiving the input. In some implementations, the simulation is launched after a preset time period has lapsed from receipt of the input.

Workload synthesis module 1110 may be configured to synthesize a workload event based on the input and aspects of the cluster. By non-limiting example, the workload may be synthesized according to a generative AI model. Workload synthesis module 1110 may be configured to identify, for example, job size, trace length, node type, and message size associated with the cluster and synthesize the workload events is based therefrom.

Simulation module 1112 may be configured to run a simulation of the cluster via an AI network simulator based on the input. The simulation module 1112 may simulate events for jobs in the cluster based on the reliability and availability of resources in the cluster. Each of the generated jobs may be associated with one or more synthesized workload events. The simulation may run at the packet level, flow level, or collective level based a desired level of detail for the simulation.

According to some embodiments, the simulation module 1112 may further include a segmenting module and sweeping module(s) configured to, for example, segment flows and perform port/path sweeping, respectively. The segmenting module may generate flow segments based on flows in the cluster. The sweeping module(s) may perform a port sweep and a path sweep on each of the flow segments in parallel, accessing flow transmission rates in each of the port and path sweeps. The sweeping may continue until the flow transmission rates converge to a final value.

Latency determining module 1114 may be configured to determine a compute and memory latency of the cluster in the simulation based on a latency model, according to embodiments.

Scheduling module 1116 may be configured to generate a job schedule for job events in the cluster. Tasks and/or jobs may be executed according to the job schedule. By non-limiting example, the job schedule may be event based such that tasks/jobs are executed based on an event occurring. The job schedule may include logical trees. The logical trees provide a way to organize and optimize network operations by offloading collective operations from, for example, GPUs to network switches. According to embodiments, each of the jobs may associated with a plurality of logical trees.

Cost analysis module 1118 may be configured to analyze cost of the system, simulation, and/or a cost associated with the cluster based on a cost model. By way of non-limiting example, the cost model may consider the determined compute and memory latency of the cluster in the cost analysis. Cost analysis module 1118 determines the computational resource usage of the cluster based on the cost model and provides the computational resource usage in an output.

Orchestration module 1120 is configured to take the results of the simulation, workload synthesis, latency determination, scheduler, and cost analysis and to generate jobs for the cluster simulation. The simulation may be run for each of the jobs based on a enqueue. The system 1100 may further include generating failures in the cluster, such that a job that fails in the simulation is added back to the enqueue. Job event state-transitions, including at least a failure, completion, or interruption state of the jobs, may be checked at one or more checkpoints during the simulation.

Output module 1122 may be configured to output simulation results to the user (e.g., client device) based on the synthesized workload, the memory latency, and the job and/or workload events. The output module 1122 may be further configured to display a message, chart, graph, or the like, illustrating the results. The output may include network performance results, a cluster performance evaluation, cluster training efficiency, resource utilization, or the like.

In some implementations, computing platform(s) 1102, remote platform(s) 1104, and/or external resources 1126 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which computing platform(s) 1102, remote platform(s) 1104, and/or external resources 1126 may be operatively linked via some other communication media.

A given remote platform 1104 may include one or more processors configured to execute computer program modules. The computer program modules may be configured to enable an expert or user associated with the given remote platform 1104 to interface with system 1100 and/or external resources 1126, and/or provide other functionality attributed herein to remote platform(s) 1104. By way of non-limiting example, a given remote platform 1104 and/or a given computing platform 1102 may include one or more of a server, a desktop computer, a laptop computer, a handheld computer, a tablet computing platform, a NetBook, a Smartphone, a gaming console, and/or other computing platforms.

External resources 1126 may include sources of information outside of system 1100, external entities participating with system 1100, and/or other resources. In some implementations, some or all of the functionality attributed herein to external resources 1126 may be provided by resources included in system 1100.

Computing platform(s) 1102 may include electronic storage 1128, one or more processors 1130, and/or other components. Computing platform(s) 1102 may include communication lines, or ports to enable the exchange of information with a network and/or other computing platforms. Illustration of computing platform(s) 1102 in FIG. 11 is not intended to be limiting. Computing platform(s) 1102 may include a plurality of hardware, software, and/or firmware components operating together to provide the functionality attributed herein to computing platform(s) 1102. For example, computing platform(s) 1102 may be implemented by a cloud of computing platforms operating together as computing platform(s) 1102.

Electronic storage 1128 may comprise non-transitory storage media that electronically stores information (e.g., results generated from one or more modules described above). The electronic storage media of electronic storage 1128 may include one or both of system storage that is provided integrally (i.e., substantially non-removable) with computing platform(s) 1102 and/or removable storage that is removably connectable to computing platform(s) 1102 via, for example, a port (e.g., a USB port, a firewire port, etc.) or a drive (e.g., a disk drive, etc.). Electronic storage 1128 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 1128 may include one or more virtual storage resources (e.g., cloud storage, a virtual private network, and/or other virtual storage resources). Electronic storage 1128 may store software algorithms, information determined by processor(s) 1130, information received from computing platform(s) 1102, information received from remote platform(s) 1104, and/or other information that enables computing platform(s) 1102 to function as described herein.

Processor(s) 1130 may be configured to provide information processing capabilities in computing platform(s) 1102. As such, processor(s) 1130 may include one or more of a digital processor, an analog processor, a digital circuit designed to process information, an analog circuit designed to process information, a state machine, and/or other mechanisms for electronically processing information. Although processor(s) 1130 is shown in FIG. 11 as a single entity, this is for illustrative purposes only. In some implementations, processor(s) 1130 may include a plurality of processing units. These processing units may be physically located within the same device, or processor(s) 1130 may represent processing functionality of a plurality of devices operating in coordination. Processor(s) 1130 may be configured to execute modules 1108, 1110, 1112, 1114, 1116, 1118, 1120, and/or 1122, and/or other modules. Processor(s) 1130 may be configured to execute modules 1108, 1110, 1112, 1114, 1116, 1118, 1120, and/or 1122, and/or other modules by software; hardware; firmware; some combination of software, hardware, and/or firmware; and/or other mechanisms for configuring processing capabilities on processor(s) 1130. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 1108, 1110, 1112, 1114, 1116, 1118, 1120, and/or 1122 are illustrated in FIG. 11 as being implemented within a single processing unit, in implementations in which processor(s) 1130 includes multiple processing units, one or more of modules 1108, 1110, 1112, 1114, 1116, 1118, 1120, and/or 1122 may be implemented remotely from the other modules. The description of the functionality provided by the different modules 1108, 1110, 1112, 1114, 1116, 1118, 1120, and/or 1122 described below is for illustrative purposes, and is not intended to be limiting, as any of modules 1108, 1110, 1112, 1114, 1116, 1118, 1120, and/or 1122 may provide more or less functionality than is described. For example, one or more of modules 1108, 1110, 1112, 1114, 1116, 1118, 1120, and/or 1122 may be eliminated, and some or all of its functionality may be provided by other ones of modules 1108, 1110, 1112, 1114, 1116, 1118, 1120, and/or 1122. As another example, processor(s) 1130 may be configured to execute one or more additional modules that may perform some or all of the functionality attributed below to one of modules 1108, 1110, 1112, 1114, 1116, 1118, 1120, and/or 1122.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

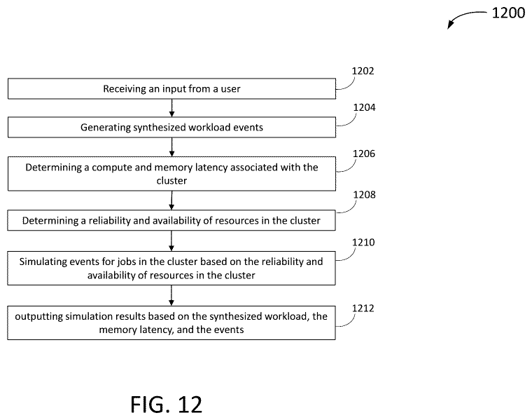

FIG. 12 is an example flow diagram (e.g., process 1200) for running unified system simulations for clusters, according to certain aspects of the disclosure. For explanatory purposes, the steps of the example process 1200 are described herein as occurring in serial, or linearly. However, multiple instances of the example process 1200 may occur in parallel, overlapping in time, almost simultaneously, or in a different order from the order illustrated in the process 1200. In addition, the blocks of the example process 1200 need not be performed in the order shown and/or one or more of the blocks of the example process 1200 need not be performed.

At step 1202, the process 1200 may include receiving an input from a user (at a client device). The input may include simulation parameters for a simulation of a cluste. The cluster may include one or more nodes in a network. In some implementations, the cluster is an HPC cluster. The input may correspond to a request based on the cluster (e.g., request for performance, resource utilization, training efficiency, etc.).

At step 1204, the process 1200 may include generating synthesized workload events based the simulation parameters of the cluster. According to some embodiments, the process 1200 may further include identifying a job size, trace length, node type, and message size associated with the cluster and generating the synthesized workload based on the identified job size, trace length, node type, and message size.

At step 1206, the process 1200 may include determining a compute and memory latency associated with the cluster. In some implementations, the compute and memory latency may be associated with running the simulation for an AI training cluster. According to some embodiments, the process 1200 may further include determining computational resource usage of the cluster based on a cost model, wherein the simulation results are generated based on the computational resource usage.

At step 1208, the process 1200 may include determining a reliability of resources in the cluster and availability of resources in the cluster for a predetermined duration of time. The reliability and availability of resources may be based on the simulation parameters provided by the user.

At step 1210, the process 1200 may include simulating events for jobs in the cluster based on the reliability and availability of resources in the cluster, each job associated with one or more synthesized workload events (generated at step 1204). According to some embodiments, the process 1200 further includes generating the jobs, wherein each of the jobs are added in sequence to an enqueue, running the simulation for each of the jobs based on the enqueue, generating failures in the cluster, wherein a job that fails in the simulation is added back to the enqueue, and tracking job event state-transitions, including at least a failure, completion, or interruption state of the jobs, at one or more checkpoints during the simulation.

According to some embodiments, the process 1200 further includes generating a job schedule for events in the cluster and offloading collective operations from graphic processing units to network switches according to logical trees, wherein each of the jobs may be associated with a plurality of logical trees.

According to some embodiments, the process 1200 further includes generating flow segments based on flows in the cluster, performing a port sweep and a path sweep on each of the flow segments in parallel, and accessing flow transmission rates in each of the port and path sweeps, wherein the port and path sweeps continue until the flow transmission rates converge to a final value. The flow segments may implement a rate allocation mechanism based on a size of the cluster.

According to embodiments, the simulation includes simulating network behavior according to one or more simulation modes based on a level of detail desired for the cluster simulation.

At step 1212, the process 1200 may include outputting simulation results based on the synthesized workload, the memory latency, and the events. The process 1200 may further include displaying the simulation results at the client device. The simulation results may include, but at not limited to, a cluster performance evaluation, cluster training efficiency, resource utilization, or the like.

The techniques described herein (for example, process 1200) may be implemented as method(s) that are performed by physical computing device(s); as one or more non-transitory computer-readable storage media storing instructions which, when executed by computing device(s), cause performance of the method(s); or as physical computing device(s) that are specially configured with a combination of hardware and software that causes performance of the method(s).

In some implementations, one or more operation blocks of FIG. 12 may be performed by a processor circuit executing instructions stored in a memory circuit, in a client device, a remote server or a database, communicatively coupled through a network (e.g., processor(s) 112 and 1130, memories 120, client device 110, server 130, database(s) 152, and network 150).

Although FIG. 12 shows example blocks of the process 1200, in some implementations, the process 1200 may include additional blocks, fewer blocks, different blocks, or differently arranged blocks than those depicted in FIG. 12.

### Hardware Overview

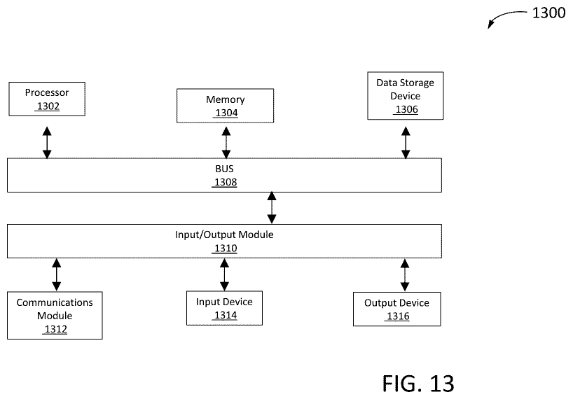

FIG. 13 is a block diagram illustrating an exemplary computer system 1300 with which aspects of the subject technology can be implemented. In certain aspects, the computer system 1300 may be implemented using hardware or a combination of software and hardware, either in a dedicated server, integrated into another entity, or distributed across multiple entities.

The computer system 1300 (e.g., server and/or client device) includes a bus 1308 or other communication mechanism for communicating information, and a processor 1302 coupled with the bus 1308 for processing information. By way of example, the computer system 1300 may be implemented with one or more processors 1302. Each of the one or more processors 1302 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

The computer system 1300 can include, in addition to hardware, code that creates an execution environment for the computer program in question, e.g., code that constitutes processor firmware, a protocol stack, a database management system, an operating system, or a combination of one or more of them stored in an included memory 1304, such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled to bus 1308 for storing information and instructions to be executed by processor 1302. Processor 1302 and memory 1304 can be supplemented by, or incorporated in, special purpose logic circuitry.

The instructions may be stored in memory 1304 and implemented in one or more computer program products, i.e., one or more modules of computer program instructions encoded on a computer-readable medium for execution by, or to control the operation of, the computer system 1300, and according to any method well-known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 1304 may also be used for storing temporary variable or other intermediate information during execution of instructions to be executed by the processor 1302.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network. The processes and logic flows described in this specification can be performed by one or more programmable processors executing one or more computer programs to perform functions by operating on input data and generating output.

The computer system 1300 further includes a data storage device 1306 such as a magnetic disk or optical disk, coupled to bus 1308 for storing information and instructions. The computer system 1300 may be coupled via input/output module 1310 to various devices. The input/output module 1310 can be any input/output module. Exemplary input/output modules 1310 include data ports such as USB ports. The input/output module 1310 is configured to connect to a communications module 1312. Exemplary communications modules 1312 include networking interface cards, such as Ethernet cards and modems. In certain aspects, the input/output module 1310 is configured to connect to a plurality of devices, such as an input device 1314 and/or an output device 1316. Exemplary input devices 1314 include a keyboard and a pointing device, e.g., a mouse or a trackball, by which a user can provide input to the computer system 1300. Other kinds of input devices can be used to provide for interaction with a user as well, such as a tactile input device, visual input device, audio input device, or brain-computer interface device. For example, feedback provided to the user can be any form of sensory feedback, e.g., visual feedback, auditory feedback, or tactile feedback, and input from the user can be received in any form, including acoustic, speech, tactile, or brain wave input. Exemplary output devices 1316 include display devices such as an LCD (liquid crystal display) monitor, for displaying information to the user.

According to one aspect of the present disclosure, the above-described systems can be implemented using a computer system 1300 in response to the processor 1302 executing one or more sequences of one or more instructions contained in the memory 1304. Such instructions may be read into memory 1304 from another machine-readable medium, such as data storage device 1306. Execution of the sequences of instructions contained in the main memory 1304 causes the processor 1302 to perform the process steps described herein. One or more processors in a multi-processing arrangement may also be employed to execute the sequences of instructions contained in the memory 1304. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., such as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. The communication network can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

The computer system 1300 can include clients and servers. A client and server are generally remote from each other and typically interact through a communication network. The relationship of client and server arises by virtue of computer programs running on the respective computers and having a client-server relationship to each other. The computer system 1300 can be, for example, and without limitation, a desktop computer, laptop computer, or tablet computer. The computer system 1300 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to the processor 1302 for execution. Such a medium may take many forms, including, but not limited to, non-volatile media, volatile media, and transmission media. Non-volatile media include, for example, optical or magnetic disks, such as the data storage device 1306. Volatile media include dynamic memory, such as the memory 1304. Transmission media include coaxial cables, copper wire, and fiber optics, including the wires that comprise the bus 1308. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter effecting a machine-readable propagated signal, or a combination of one or more of them.

The techniques described herein may be implemented as method(s) that are performed by physical computing device(s); as one or more non-transitory computer-readable storage media storing instructions which, when executed by computing device(s), cause performance of the method(s); or, as physical computing device(s) that are specially configured with a combination of hardware and software that causes performance of the method(s).

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

To the extent that the terms “include,” “have,” or the like is used in the description or the claims, such term is intended to be inclusive in a manner similar to the term “comprise” as “comprise” is interpreted when employed as a transitional word in a claim. The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

The subject matter of this specification has been described in terms of particular aspects, but other aspects can be implemented and are within the scope of the following claims. For example, while operations are depicted in the drawings in a particular order, this should not be understood as requiring that such operations be performed in the particular order shown or in sequential order, or that all illustrated operations be performed to achieve desirable results. The actions recited in the claims can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products. Other variations are within the scope of the following claims.

It should be understood that the original applicant herein determines which technologies to use and/or productize based on their usefulness and relevance in a constantly evolving field, and what is best for it and its players and users. Accordingly, it may be the case that the systems and methods described herein have not yet been and/or will not later be used and/or productized by the original applicant. It should also be understood that implementation and use, if any, by the original applicant, of the systems and methods described herein are performed in accordance with its privacy policies. These policies are intended to respect and prioritize player privacy, and to meet or exceed government and legal requirements of respective jurisdictions. To the extent that such an implementation or use of these systems and methods enables or requires processing of user personal information, such processing is performed (i) as outlined in the privacy policies; (ii) pursuant to a valid legal mechanism, including but not limited to providing adequate notice or where required, obtaining the consent of the respective user; and (iii) in accordance with the player or user's privacy settings or preferences. It should also be understood that the original applicant intends that the systems and methods described herein, if implemented or used by other entities, be in compliance with privacy policies and practices that are consistent with its objective to respect players and user privacy.

What is claimed is:

1. A computer-implemented method for running simulations on clusters, the method comprising:
receiving, from a user, simulation parameters for a simulation of a cluster;
generating synthesized workload events based the simulation parameters of the cluster;
determining a memory latency associated with the cluster;
determining a reliability and availability of resources in the cluster for a predetermined duration of time;
simulating events for jobs in the cluster based on the reliability and availability of resources in the cluster, each job associated with one or more synthesized workload events; and
outputting simulation results based on the synthesized workload, the memory latency, and the events.

2. The method of claim 1, wherein the cluster is a high-performance computing cluster comprising one or more nodes in a network.

3. The method of claim 1, wherein simulation results include at least one of a cluster performance evaluation, cluster training efficiency, and resource utilization.

4. The method of claim 1, wherein generating the synthesized workload further includes identifying a job size, trace length, node type, and message size associated with the cluster, wherein the synthesized workload events is based on the identified job size, trace length, node type, and message size.

5. The method of claim 1, further comprising determining computational resource usage of the cluster based on a cost model, wherein the simulation results are generated based on the computational resource usage.

6. The method of claim 1, further comprising:
generating a job schedule for events in the cluster; and
offloading collective operations from graphic processing units to network switches according to logical trees, wherein each of the jobs are associated with a plurality of logical trees.

7. The method of claim 1, further comprising simulating network behavior according to one or more simulation modes based on a level of detail desired for the simulation.

8. The method of claim 1, wherein simulating the events for the jobs further comprises:
generating the jobs, wherein each of the jobs are added in sequence to an enqueue;
running the simulation for each of the jobs based on the enqueue;
generating failures in the cluster, wherein a job that fails in the simulation is added back to the enqueue; and
tracking job event state-transitions, including at least a failure, completion, or interruption state of the jobs, at one or more checkpoints during the simulation.

9. The method of claim 1, further comprising:
generating flow segments based on flows in the cluster;
performing a port sweep and a path sweep on each of the flow segments in parallel; and
accessing flow transmission rates in each of the port and path sweeps, wherein the port and path sweeps continue until the flow transmission rates converge to a final value.

10. The method of claim 9, wherein the flow segments implement a rate allocation mechanism based on a size of the cluster.

11. A system configured for running simulations on clusters, the system comprising:
one or more processors; and
a memory comprising instructions stored thereon, which when executed by the one or more processors, causes the one or more processors to:
receive, from a user, simulation parameters for a simulation of an artificial intelligence (AI) training cluster;
generate synthesized workload events based the simulation parameters of the AI training cluster, the AI training cluster comprising one or more nodes in a network;
determine a memory latency associated with the AI training cluster;
determine a reliability and availability of resources in the AI training cluster for a predetermined duration of time;
simulate events for jobs in the AI training cluster based on the reliability and availability of resources in the AI training cluster, each job associated with one or more synthesized workload events; and
output simulation results based on the synthesized workload, the memory latency, and the events.

12. The system of claim 11, wherein simulation results include at least one of a cluster performance evaluation, cluster training efficiency, and resource utilization.

13. The system of claim 11, wherein the instructions, when executed by the one or more processors, cause the one or more processors to identify a job size, trace length, node type, and message size associated with the cluster, wherein the synthesized workload events is based on the identified job size, trace length, node type, and message size.

14. The system of claim 11, wherein the instructions, when executed by the one or more processors, cause the one or more processors to determine computational resource usage of the cluster based on a cost model, wherein the simulation results are generated based on the computational resource usage.

15. The system of claim 11, wherein the instructions, when executed by the one or more processors, cause the one or more processors to:
generate a job schedule for events in the cluster; and
offload collective operations from graphic processing units to network switches according to logical trees, wherein each of the jobs are associated with a plurality of logical trees.

16. The system of claim 11, wherein the instructions, when executed by the one or more processors, cause the one or more processors to simulate network behavior according to one or more simulation modes based on a level of detail desired for the simulation.

17. The system of claim 11, wherein the instructions, when executed by the one or more processors, cause the one or more processors to:
generate the jobs, wherein each of the jobs are added in sequence to an enqueue;
run the simulation for each of the jobs based on the enqueue;
generate failures in the cluster, wherein a job that fails in the simulation is added back to the enqueue; and
track job event state-transitions, including at least a failure, completion, or interruption state of the jobs, at one or more checkpoints during the simulation.

18. The system of claim 11, wherein the instructions, when executed by the one or more processors, cause the one or more processors to:
generate flow segments based on flows in the cluster;
perform a port sweep and a path sweep on each of the flow segments in parallel; and
access flow transmission rates in each of the port and path sweeps, wherein the port and path sweeps continue until the flow transmission rates converge to a final value.

19. The system of claim 18, wherein the flow segments implement a rate allocation mechanism based on a size of the cluster.

20. A non-transitory computer-readable storage medium comprising instructions stored thereon, which when executed by one or more processors, cause the one or more processors to perform operations for running simulations on clusters, comprising:
receiving from a user, simulation parameters for a simulation of an artificial intelligence (AI) training cluster;
generating synthesized workload events based the simulation parameters of the AI training cluster, the AI training cluster comprising one or more nodes in a network;
determining a memory latency associated with the AI training cluster;
determining a reliability and availability of resources in the AI training cluster for a predetermined duration of time;
simulating events for jobs in the AI training cluster based on the reliability and availability of resources in the AI training cluster, each job associated with one or more synthesized workload events; and
outputting simulation results based on the synthesized workload, the memory latency, and the events.
